(19) United States
(12) Patent Application Publication
(10) Pub. No.: US 2013/0055818 A1
(43) Pub. Date: Mar. 7, 2013

(54) PRESSURE CONTROL IN CONTINUOUS PLASMA DEPOSITION PROCESSES

(71) Applicant: Joachim Doehler, White Lake, MI (US)

(72) Inventor: Joachim Doehler, White Lake, MI (US)

(73) Assignee: United Solar Ovonic LLC, Auburn Hills, MI (US)

(21) Appl. No.: 13/224,112

(22) Filed: Sep. 1, 2011

(51) Int. Cl. G01L 11/02

(52) U.S. Cl. 73/705

(57) ABSTRACT

Processes of identifying small pressure irregularities in a system used for continuous plasma deposition are provided. Sensitive light scattering is used to detect the presence of nucleated particles in a detection area that is outside the plasma region of high electric field whereby the presence of the particles indicates a pressure abnormality in the plasma deposition chamber. The pressure of the plasma deposition chamber is then adjusted to reduce or eliminate the presence of particles within the detection area and to optimize deposition of material on a substrate.

### FIELD OF THE INVENTION

This invention relates generally to methods for producing improved photovoltaic devices and more particularly to detecting minute pressure differentials from desired norms in one or more regions of a plasma deposition chamber.

### BACKGROUND OF THE INVENTION

The high volume production of large area semiconductor devices, such as photovoltaic devices, is often performed in a continuous deposition process. In processes of this type, one or more webs of substrate material are continuously advanced from a payoff station through a series of deposition chambers wherein various layers of semiconductor material are deposited onto the substrate. The substrate is then wound into rolls in a take-up chamber. The deposition process often includes high vacuum conditions that may vary among adjacent deposition chambers.

Each of the deposition chambers may use similar deposition techniques. Illustratively, a series of deposition chambers may each use plasma deposition techniques to add layers to the moving substrate. The plasma region of a deposition chamber is defined as the region between the cathode and the substrate wherein process gases are disassociated by the plasma for deposition onto the substrate. The process gases, that generally include Silane, are introduced into the deposition chamber adjacent the plasma region, are pulled across the top surface of the cathode, and are withdrawn along with the non-deposited plasma through a port located at the underside of the cathode or by flow out the side of the deposition chamber. This method of introduction and evacuation from regions adjacent to the plasma region attempt to prevent unwanted deposition onto the surfaces of the chamber. Unfortunately, not all of the process gases and plasma are immediately withdrawn and may be free to escape from the plasma region and contact the walls of the deposition chamber. The escaped process gases and plasma nucleate to form a silane-based powder that can settle between semiconductor layers deposited on the substrate. The powder particles may seriously impair or short out a photovoltaic device produced from the semiconductor layers, particularly when the powder forms between the p and n semiconductor layers. Thus, the prior art recognizes the presence of this powder as an unwanted side reaction to be minimized.

Each of the deposition chambers is typically used to deposit a specific and singular type of layer onto a substrate. The identity of the deposited layer is controlled by the type of process gases introduced into the deposition chamber. In the formation of a typical solar cell of a p-i-n type configuration, a first chamber is dedicated for depositing a p-type amorphous silicon alloy, a second chamber is dedicated for depositing an intrinsic amorphous silicon alloy, and the third chamber is dedicated for depositing an n-type amorphous silicon alloy. Each of the alloys must be of high purity. Contamination introduced from the plasma itself, such as the silicon-based powders referred to above, or contamination from adjacent chambers threatens to detrimentally affect the performance of the resulting material. Contamination can result in poor film quality, changes in the material resistivity, and possibly device failure.

Inter-chamber connections are formed by one or more gas-gates that allow the substrate to pass into a chamber and form a possible gaseous connection between two chambers. Typical gas-gates are established at the connections between the chambers through which unidirectional gas flow is established. Inert sweep gases are directed from the high pressure side to the low pressure side of the gas gate to substantially reduce back diffusion of dopant process gases through the gas gate passageway and thereby reduce contamination of the intrinsic semiconductor layers.

The gas gates include small gaps between the coated side of the moving substrate web and any other parts of the gate or the deposition chamber. These gaps are necessary for the simple reason that the growing material surface cannot come in contact with any solid object or it will be damaged. The size of these gaps depends on the processes performed in adjacent chambers. For example in many three layer continuous deposition processes, these gaps are typically 0.3 inches, but can be larger or smaller. Very narrow gaps may be used when adjacent chambers are used for deposition of multiple layers of the same material. In these instances, the adjacent chambers are separately controlled by individual pressure control systems. Small variations in pressure between the adjacent chambers can result in unwanted movement of excited species or gases from one chamber into another, and can, in turn, affect the gas flows within the chambers. Thus, tight regulation of interchamber pressures is highly desirable.

The necessity of the gaps between chambers increases the difficulty of maintaining the necessary pressures within adjacent chambers. Even slight pressure differentials from the desired levels can detrimentally affect the deposition of the substrate material in the layer. Techniques developed to measure the pressure differentials between chambers and within a single chamber are inadequate to detect these minute pressure differentials. A need exists for methods of detecting very small pressure imbalances to improve the plasma deposition process in a continuous multi-chamber system.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

Processes are provided for detecting the presence or absence of a pressure irregularity within a plasma deposition chamber. The processes include propagating a light beam across a detection area within a plasma deposition chamber, the light beam propagating along a propagation axis and detecting for a first detection time the presence or absence of scattered light at a first detector positioned to receive light at a first angle to the propagation axis. The presence or absence of scattered light is indicative of the presence or absence, respectively, of particles in the detection area such that identifying the presence or absence of a pressure irregularity in the chamber is achieved by the detecting. A pressure irregularity is optionally 0.001 times the operating pressure of the chamber or less. The presence of scattered light optionally identifies a pressure within said chamber that is in excess of a target pressure.

The pressure within the chamber is optionally adjusted in response to detecting scattered light at the detector. In some embodiments, the detection of a particle is indicative of too great a pressure in a plasma deposition chamber such that the chamber operating pressure is reduced after detecting.

Detecting is optionally for a detection time. More than one detection time is optionally used where the number of particles detected in each detection time is used individually or compared to the number of particles detected in another detection time. A detection time is optionally at or between 1 second and 10 minutes. In some embodiments, a detection time is 10 seconds or less, or 5 seconds or less. A first detection time and a second or other detection time are optionally identical or different.

A light beam optionally has a bandwidth of 100 nm or less. Optionally, a light beam has a wavelength less than 1100 nm. In some embodiments, a light beam has a wavelength of 700 nm or less. A light beam is optionally monochromatic. Optionally, a light beam is emitted from a narrow band light source, from a laser, or both. A laser is optionally a HeNe laser. In some embodiments, a process includes polarizing a light beam. In some embodiments, a process includes collimating a light beam.

The scattered light is optionally transmitted at a first angle. A first angle is optionally at or between 3 degrees and 140 degrees, optionally at or between 2 degrees and 15 degrees. In some embodiments, light scattered at more than one angle is detected. A first angle and a second angle are optionally not the same. A second angle is optionally greater than a first angle. A second angle is optionally at or between 15 and 140 degrees, optionally to or between 80 and 100 degrees. A first angle, a second angle, or other angle is optionally zero degrees.

A detection area is optionally on the high-pressure side of a plasma region located within a plasma deposition chamber. In some embodiments, a detection area is defined by a plane of an edge piece located on the high-pressure side of a plasma region within the plasma deposition chamber. Optionally, two or more detection areas are employed within a single plasma deposition chamber. Detecting the presence of particles in any one of the detection areas optionally indentifies a pressure irregularity within the plasma deposition chamber or a portion thereof.

### BRIEF DESCRIPTION OF THE DRAWINGS

The drawings are presented for illustrative purposes alone, and are not a limitation on the invention. The drawings are not to scale.

FIG. 1 represents an exemplary plasma deposition chamber whereby two substrates pass through the chamber in which material from the plasma is deposited on the substrates and a detection area positioned outside the region of high electric field includes a beam of collimated linearly polarized light that is used for detection of the presence or absence of particles in the detection area by light scattering measurements.

### DETAILED DESCRIPTION OF EMBODIMENTS OF THE INVENTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the process is described as an order of individual steps or using specific materials, it is appreciated that described steps or materials may be interchangeable or otherwise rearranged such that elements from various portions of the disclosure can be combined in several ways as is readily appreciated by one of skill in the art.

A unique method for detecting minute pressure differentials from desired levels in a plasma deposition chamber is provided. The processes capitalize on the presence of nucleating contaminant particles at or near the edge regions near to where a substrate passes when entering or exiting a plasma region. The edge regions are located outside the plasma region of high field and are smaller than the plasma “dark space” such that, ideally, no plasma exists in this region. If these edge regions are allowed to contain stagnant gas, however, the plasma excited species can migrate into these regions due to minute pressure variations and can then react with the process gas to nucleate into contaminate particles. The inert sweep gas, such as hydrogen, is intended to police these gaps thereby preventing this nucleation reaction from occurring.

The nucleated particles are considered in the art as detrimental to the plasma deposition process. The processes described herein, however, take this detrimental material and turn its presence into a benefit to detect pressure irregularities in a plasma deposition chamber. This allows for rapid and highly sensitive detection of pressure imbalances in a plasma deposition chamber that can be readily remedied thereby improving conditions for plasma deposition within an associated chamber and improving the quality of the deposited material. The invention has utility as a method for detecting pressure irregularities or imbalances within one or more plasma deposition chambers.

Processes for identifying, and optionally correcting, a pressure irregularity are provided including propagating a light beam across a detection area, optionally defined by an edge definition piece, of a plasma deposition chamber whereby the light beam propagates along a propagation axis, and detecting for or at a first time the presence or absence of light at a detector that is positioned to receive light at a first angle to the propagation axis. The presence of light at an angle to a propagation axis is therefore scattered light. The light scattered by particles near the edge definition piece are formed in the presence of a pressure irregularity in the plasma deposition chamber. Thus, detecting scattered light indicates a pressure irregularity.

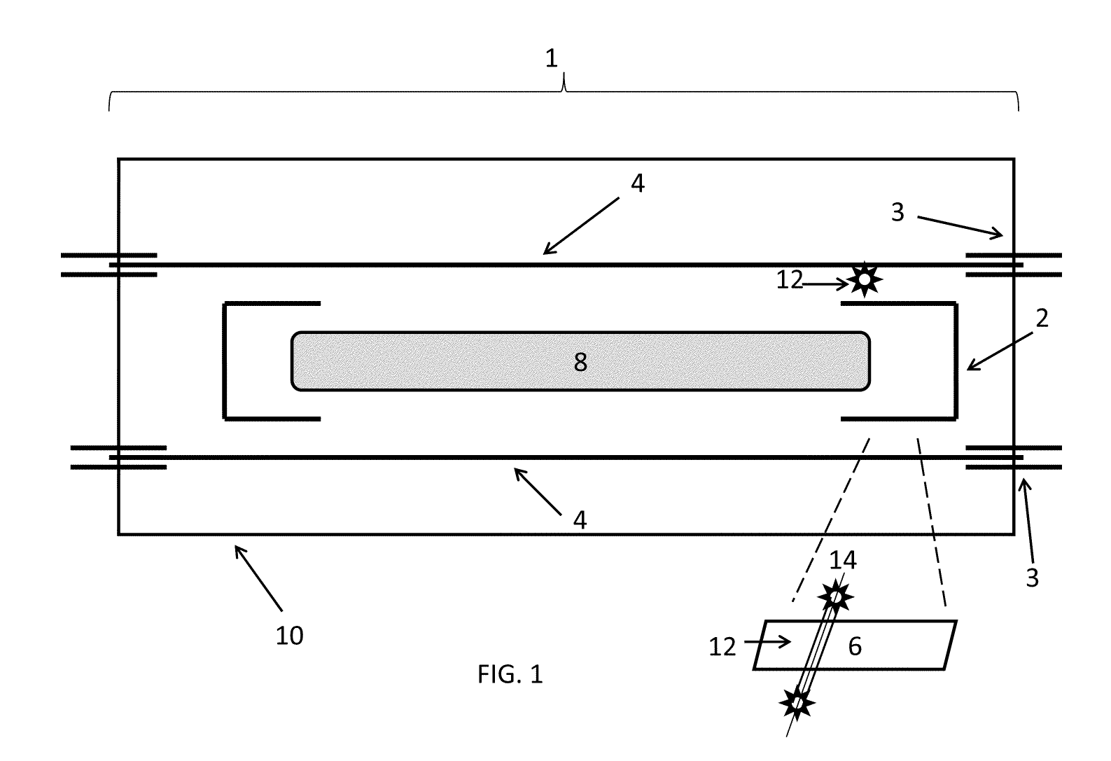

A typical plasma deposition chamber 1 for use in a continuous process includes one or more edge definition pieces illustrated at 2 in FIG. 1. An edge definition piece 2 has a surface that passes near to a substrate 4 without making physical contact. The area between the substrate 4 and the edge definition piece 2 optionally serves as a detection area 6. A substrate 4 enters the chamber 1 through one or more gaps 3. The cathode 8 is typically connected to a DC or AC power source and the surrounding parts are held at ground potential setting up an electrical field to establish and maintain a plasma. The cathode and surrounding parts are held in a vacuum chamber 10. The light beam 12 is propagated across the detection area 6 along a propagation axis 14. For illustrative purposes, axis 14 is shown to be parallel to the web 4.

The light source for producing a light beam can be a laser, optionally a HeNe-based laser, a neodymium-based laser, or other laser light source emitting light of a desired wavelength, or it can be a non-laser light source such as an arc lamp. In some embodiments, light emitted from a light source is optionally intrinsically polarized or it can by polarized by the use of an external polarizer such as a surface positioned at Brewster's angle or other polarizer to linearly polarize the light from the light source. Optionally, a light beam is not polarized, or is not linearly polarized. In some embodiments, the light is collimated. The description is directed to a polarized light beam, principally a linearly polarized light beam, for illustrative purposes only. Several embodiments use alone or in addition to a polarized light beam a non-polarized light beam.

A detection area, shown illustratively at 6 in FIG. 1, is a region outside the high field area within a plasma deposition chamber and may be smaller than the plasma's dark space such that under optimal conditions no plasma exists in the detection area. More than one detection area is optionally used. Optionally, each substrate is associated with a detection area. In FIG. 1, two substrates 4 are used in a single chamber 1. In some embodiments, each of the substrates passes near an edge definition piece forming two detection areas 6. As such, in some embodiments, two detection areas are used sequentially, simultaneously, or individually to detect the presence or absence of a pressure irregularity in a plasma deposition chamber or portion thereof.

In some embodiments, the detection area is on the high-pressure side of the plasma region. It is appreciated that a detection area is optionally at a high-pressure side, a low-pressure side, other locations outside the plasma region, or combinations thereof. A plasma deposition area is the area within the electrical field where plasma is normally created for deposition onto a substrate. The sweep gas enters the plasma region through the detection area. The purpose of the sweep gas is to prevent stagnant gas in the detection area. If stagnant gas (little to no flow) is present in the detection area, particles of excited species from the plasma are able to diffuse into the detection area and begin nucleating in the gas phase. If minute pressure variations are present in the plasma deposition chamber, excited species are able to actively flow out of the plasma region and into the detection area where they nucleate to form larger particles. The nucleated particles are detectable in the detection area by light scattering measurements as described herein or otherwise known in the art. Thus, the presence of detected particles in the detection area is indicative of a pressure irregularity in the plasma deposition chamber leading to either stagnant gas flow or reverse flow due to pressure outside the desired level within the deposition chamber. Thus, in some embodiments, a detection area is optionally a region normally swept by sweep gas positioned outside the plasma space. An edge piece 2 optionally has a side that defines a plane that, in some embodiments, is used in whole or in part as a detection area whereby the detection area is optionally the region between the edge definition piece and the substrate, or a portion of this region. The description herein is directed to a detection area defined by one side of an edge piece for descriptive and illustrative purposes alone. This is not meant as a limitation on the location of the detection area, but is but one example of a detection area suitable for detecting pressure irregularities within a plasma deposition chamber.

If during propagation of a light beam, a particle of sufficient size is present in along the propagation axis, the particle will scatter the light in a direction at an angle to the propagation axis. A detector placed to receive light transmitted along a desired first angle to the propagation axis will detect the scattered light and, optionally, record the detection indicating the presence of a particle in the detection area. For particles that are approximately equal to or larger than the wavelength of the light, forward scatter light intensity is enhanced. See Gise, in Handbook of Contamination Control in Microelectronics, edited by D. Tolliver (Noyes, Park Ridge, N.J., 1988), pg. 389. Thus, the light used optionally has a wavelength equal to or smaller than the desired particle size to be detected. A light source optionally has a wavelength that is monochromatic or polychromatic. When a polychromatic light source is used, some embodiments pass the light through one or more filters to reduce the wavelengths to a narrow wavelength band, optionally a band of 100 nm or less. A light beam optionally has a wavelength less than 1100 nm, 1000 nm, 900 nm, 800 nm, 700 nm, 600 nm, 500 nm, 400 nm, 300 nm, 200 nm, 100 nm, 50 nm, or less. In some embodiments, the wavelength is from 10 nm to 1100 nm or any value or range therebetween.

It is appreciated that the larger the particles to be detected at the lower limit of size, the greater the residence time of contaminant plasma in the detection area. Thus, a threshold value of pressure irregularity is optionally used by adjusting or using a light beam of a desired wavelength, with shorter wavelengths capable of detecting smaller particles, and longer wavelengths detecting larger particles. In some embodiments, a HeNe laser is used. A HeNe laser typically emits light with a wavelength of 632.8 nm. Optionally, a narrow band optical system other than a laser is used in place of or along with a laser.

The light beam is optionally polarized. Various techniques of producing linear polarized light are known in the art. Optionally, a light beam from a light source is directed to a surface at Brewster's angle. Brewster's angle is the angle of incidence of which light of a particular polarization is reflected from the surface of a material at 90 degrees to the direction of the refracted light. At Brewster's angle, the reflected light is perfectly linearly polarized. Brewster's angle depends on the refractive indices of the two media in which the light is traveling and is calculable by the equation:

θ=tan⁻¹(n₂/n₁) (I)

where n₁ and n₂ are the refractive indices of the two media. Thus, an incident light beam can be perfectly linearly polarized by reflection. It is appreciated that other methods of producing linearly polarized light are similarly operable.

The light beam is propagated across a detection area. In some embodiments, this is accomplished by providing a window at one end of a detection area that allows light of the desired wavelength to pass through and be emitted along the propagation axis. A window is made of any suitable material such as quartz, glass, or other material known in the art. A window optionally contains one or more coatings that also transmit the light. A coating optionally prevents buildup of plasma material or other material on the surface of the window. To minimize reflection losses at the windows, the light beam is optionally oriented at Brewster's angle θ_{b} to an imaginal line normal to the plane of the window. For glass or plastic windows θ_{b} is about 56°.

The transmitted light is propagated across the detection area along a propagation axis. A propagation axis is optionally parallel to the surface of a detection area, but is not necessarily limited as such. The propagation axis is optionally parallel to the detection area or any angle thereto. Optionally, a propagation axis is perpendicular to the surface defining the detection area. A propagation axis is optionally any angle from parallel to perpendicular to a propagation axis in any direction. The disclosure will illustratively use a propagation axis that is parallel to a plane formed by an end piece or parallel to the surface of a substrate for illustrative purposes alone. One of ordinary skill in the art can readily envision any necessary physical or other modifications necessary to accomplish the processes at other angles of the propagation axis.

In the presence of a particle within the detection area that moves or is positioned along the propagation axis, where the particle is of suitable size, light traveling along the propagation axis will be scattered a particular direction dependent on the size of the particle and the wavelength of the propagated light. One or more detectors are positioned to receive light scattered at one or more first angles from the propagation axis. A detector is positioned to receive scattered light if it is located along the path traveled by scattered light or is located in a position which light reflected, refracted, focused, or otherwise directed will contact the detector. Thus, the description of a detector positioned to receive scattered light can be a position to directly or indirectly receive the scattered light. Illustratively, an angle is from zero to 180 degrees, or any value or range therebetween. In some embodiments, an angle is 90 degrees. Optionally, an angle is at or between zero and two degrees. Optionally, an angle is 90 degrees or less. It is appreciated that with some particles, the scatter light is reflected light. Reflected light can propagate at virtually any angle. As such, an angle is optionally any angle desired for detection.

One or more lenses, minors, or detectors are optionally placed at a first angle, a second angle or any other angle or range of angles from the propagation axis. Optionally, a lens or minor is used to capture light from a wide range of angles from the propagation axis and focus the light onto a detector so as to be able to detect scattered light scattered from a particle at any position within the detection area and particles of various sizes present in the detection area. In some embodiments, the particle sizes are not determined. In some embodiments, the mere presence of particles, optionally at or above a background threshold, within the detection area is sufficient to indicate a pressure abnormality in a deposition chamber. Illustratively, a section of the wall of a plasma deposition chamber transmits scattered light to a collecting lens or minor that is capable of focusing the light to the surface of a detector. The detection of the light within the range of angles from the propagation axis is indicative of a pressure abnormality in the plasma deposition chamber. Optionally, a plurality of detectors, mirrors, and or lenses is positioned at various angles (i.e. at various positions) from a propagation axis. Optionally, a light scattering detector, lens, minor, or combination is employed at a large angle. Optionally, a scattering detector, lens, minor, or combination is employed at a small angle. In some embodiments, light scattering detectors, lenses, mirrors, or combinations are employed at both a large angle and a small angle. As used herein a large angle is at or between 140 degrees and 15 degrees. A small angle is used herein as at or between zero and less than 15 degrees, optionally, at or between 2 and 10 degrees. Various angles and optics useful in the herein disclosed processes are found in U.S. Pat. No. 6,404,493.

One or more filters are optionally positioned between a detector and a detection area to filter out light emitted from the plasma itself. As such, a process optionally includes passing scattered light through a filter. A filter is optionally a narrow band filter that optionally has a bandpass of 10 nm or less with the wavelength of the scattered light falling within the passable light band. It is appreciated that filters other than narrow band filters are similarly operable such as cutoff filters that allow light above or below a certain wavelength to pass while preventing light of the wavelength(s) emitted by the plasma from contaminating the signal received by the detector. A filter is optionally positioned between the detection area and the detector. As such, a filter is optionally positioned in between a lens or mirror and a detector, or is positioned in front of a lens or mirror. Other suitable positions are similarly operable.

Some embodiments detect light transmitted along the propagation axis such that a detector, lens, minor, or combination are placed at three degrees or less, optionally zero degrees, from the propagation axis. When a particle scatters light, the amount of light reaching the transmission detector is reduced such that particle counting can be achieved by detection of a reduction of light at this detector. An obscuration bar is optionally employed in front of a detection mechanism (e.g. lens, minor, detector, or combination) to prevent direct illumination of the detector. Optionally, a detector is placed at the end of a light trap. In some embodiments, a light trap is provided along the propagation axis. A light trap and system for detecting particles in a gas as disclosed in U.S. Application Publication No. 2010/0002229 is optionally used in the processes provided herein. A light trap includes a column coated with absorbtive material that has a diameter (collection area) of 3 degrees or less from the propagation axis and is useful for particle counting.

A detector as used herein is any device known in the art for detecting light energy. Illustrative examples of detectors include a phototube, photodiode, or other detector capable of detecting the presence of light. In some embodiments, a detector is electrically associated with one or more instruments for recording, counting, sizing, or otherwise characterizing the particles or number of particles detected by the detector. Such instruments are known in the art and are commercially available.

A detection area is optionally defined by a plane between the surface of a substrate and an end piece. The propagation axis optionally traverses the plane substantially parallel thereto, perpendicular thereto, or at any other angle. In some embodiments, the propagation axis traverses the plane at any angle relative to the direction of substrate travel. Illustratively, a propagation axis traverses a plane from a position at or in the direction of the outer edge of the edge piece to the inner (e.g. toward the cathode) edge of the edge piece, or vice versa. Optionally, more than one light beam is used with the light beams emitted from a plurality of locations optionally positioned side to side, vertically, or combinations thereof relative to the plane of the detection area.

A process optionally includes identifying the presence of a pressure irregularity in the plasma deposition chamber by detecting the presence of one or more particles in the detection area over a measurement time. A pressure irregularity detectable by the processes is optionally 0.01 times the operating pressure of a chamber, or less. Optionally, a pressure irregularity is 5×10⁻⁵ times the operating pressure of a chamber, or less. Optionally, a pressure irregularity is 0.01, 0.001, 0.0001, 0.00001, 0.000001 times the operating pressure of a chamber or less, or any value or range at or between 0.01 and 0.000001 times the operating pressure of a chamber. In some embodiments, a pressure irregularity is 0.001 Torr or less. In some embodiments, a pressure irregularity is 0.0002 Torr or less. As such, the processes provided are capable of detecting minute pressure differentials that are undetectable in total, or in sufficient time for correction by other methods known in the art.

Detecting is optionally the identification of a particle or number of particles above a background or threshold value. In some embodiments, the number of particles is counted over a detection time. In some embodiments, if the number of particles of any or a particular size is detected or is detected as above a threshold value, a pressure irregularity is detected. A threshold value is optionally determined by a user or is integral with a particular plasma deposition process and may be adjusted or fixed. A background or threshold value is optionally determined over a series of standardization runs. One of ordinary skill in the art with the present specification understands how to measure the particle numbers, sizes, or other parameters to establish a threshold value. The detection of the number of particles in a detection time, optionally at or above a threshold value indicates a pressure irregularity in the plasma deposition chamber.

A detection time is any time useful for the detection, counting, or both of one or more particles in the presence of a pressure irregularity. A detection time is optionally from 0.001 seconds to 10 minutes or more, or any value or range at or between 0.001 seconds and 30 minutes. A detection time is optionally, 1, 2, 3, 4, 5, 6, 7, 8, 9 or 10 seconds. A detection time is optionally 1, 2, 3, 4, 5, 6, 7, 8, 9 or 10 minutes. With increasing detection time, the sensitivity of the detection is increased as the odds of a particle passing across the propagation axis increases.

In some embodiments, the number of detected particles at a small detection angle relative to a large detection angle indicates a pressure irregularity. Smaller particles relative to the wavelength of the light used in the light beam are expected to have greater large angle light scattering. Larger particles (at or above the wavelength of the light beam) scatter light at smaller angles. Thus, while particle characterization such as sizing is not essential in some embodiments, rough determination of particle size is useful as a measure of the extent of a pressure irregularity. The presence of larger particles may be indicative of a more severe pressure irregularity than smaller particles. As the residence time of excited species in a detection area increases, or the distance from the plasma region increases, greater nucleation is expected to occur in the presence of a pressure irregularity. The less severe the irregularity, the greater the relative number of smaller particles. The presence of particles in the detection area not only is capable of detecting a pressure irregularity, but is also optionally used to quantify a pressure adjustment in the chamber. A process optionally, therefore, includes adjusting the pressure inside the plasma deposition chamber in response to identifying the presence of a particle in the detection area.

The presence of nucleated or other particles in a detection area is indicative of a pressure abnormality that allows such particles to move or form in the detection area. Processes of identifying such a pressure irregularity are achieved by detecting the presence or absence of one or more particles in the detection area. Light scattering techniques as described herein or, optionally, as known in the art, are useful for identifying a pressure irregularity in a plasma deposition chamber such that the pressure can be adjusted to optimize material deposition on a substrate present in or moving through the plasma deposition chamber. The inventive processes are suitable for detection of pressure irregularities, source gas irregularities, contaminants, or other conditions or materials that are desirable or detrimental to a plasma deposition process. The processes of the invention are operable in any plasma deposition chamber. Illustratively, a plasma deposition chamber is one or more of a plurality of deposition chambers such as those linked for use in a continuous deposition process.

Various aspects of the present invention are illustrated by the following non-limiting examples. The examples are for illustrative purposes and are not a limitation on any practice of the present invention. It will be understood that variations and modifications can be made without departing from the spirit and scope of the invention.

### Example 1

A continuous plasma deposition process is used essentially as described in U.S. Pat. Nos. 4,542,711; 4,410,558; 4,438,723; and 4,492,181. In these processes, the substrate is advanced through three processing chambers wherein each deposits a single and specific material onto the moving substrate. The first chamber (toward the source raw substrate) is used to deposit a p-type amorphous silicon semiconductor alloy material, the second chamber is used to deposit an intrinsic amorphous silicon semiconductor alloy, and the third chamber is used to deposit an n-type amorphous silicon semiconductor alloy material. The gates between chambers 1 and 2 and chambers 2 and 3 are essentially as described in U.S. Pat. No. 5,374,313. Each of the plasma deposition chambers is individually fitted with a particle detection system that includes a 3 mW HeNe laser for generation of collimated light (wavelength 632.8 nm) that is linearly polarized by reflection. A optical-quality quartz transmission window is positioned on the chamber wall at Brewster's angle such that the polarized light passes through the window with minimized reflection and propagates across a detection area that traverses an end piece outside the plasma region of the chamber. Directly opposite the window and along the propagation axis is a black anodized aluminum plate for absorption of fully transmitted light. Along the plane of the detection area, and at an angle of 2 to 15 degrees from the propagation axis is a second transmission window that includes an optical quality quartz lens for focusing light to a single focal location. At the focal location is a photodiode-type detector that is electronically connected to a recording device for recording a photon of scattered light.

Some experiments are performed with a third transmission window positioned within the edge piece that has a dimension such that light scattered at a large angle of at or between 80 and 100 degrees from the propagation angle is collectable by the lens and focused on a second photodiode detector also electrically coupled with an instrument for recording the presence of a scattered photon. The detection using both detectors is repeated and pressure adjusted when particles are observed as detected by either of the detectors.

Additional experiments are performed where the propagation axis traverses the detection area at an angle relative to the walls of the deposition chamber. This angle allows a lens positioned on one wall of the detection chamber to receive light that is scattered at an angle of greater than 90 degrees to 2 degrees, or less, to be focused onto a single detector. Thus, a wide range of scattering angles from many points along the propagation axis is detectable providing excellent sensitivity to pressure irregularities.

Standard plasma deposition is performed while collecting light scattering measurements over 10 second intervals. Upon detection of a particle or plurality of particles, the pressure of the chamber in which particles are detected is adjusted until no additional particles are observed over a detection time of 10 seconds.

Various modifications of the present invention, in addition to those shown and described herein, will be apparent to those skilled in the art of the above description. Such modifications are also intended to fall within the scope of the appended claims.

It is appreciated that all materials and instruments used herein are obtainable from commercial sources known in the art unless otherwise specified, or are readily manufactured by those of ordinary skill in the art.

Patents and publications mentioned in the specification are indicative of the levels of those skilled in the art to which the invention pertains. These patents and publications are incorporated herein by reference to the same extent as if each individual application or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A process of identifying a pressure irregularity in a plasma deposition chamber comprising:
propagating a light beam across a detection area within a plasma deposition chamber, said light beam propagating along a propagation axis;
detecting for a first detection time the presence or absence of scattered light at a first detector, said detector positioned to receive light at a first angle to said propagation axis; and
identifying the presence or absence of a pressure irregularity in said chamber by said step of detecting the presence or absence of scattered light.

2. The process of claim 1 wherein the step of identifying identifies a pressure irregularity in excess of a target pressure.

3. The process of claim 1 further comprising the step of adjusting the pressure within said plasma deposition chamber in response to detecting scattered light.

4. The process of claim 1 wherein said first detection time is at or between 1 second and 10 minutes.

5. The process of claim 1 wherein said step of propagating a light beam propagates a polarized light beam having a wavelength of 1100 nm or less.

6. The process of claim 1 wherein said first angle is at or between 3 degrees and 140 degrees.

7. The process of claim 1 wherein said first angle is at or between 2 degrees and 15 degrees.

8. The process of claim 1 wherein said light beam is propagated using a HeNe laser.

9. The process of claim 1 further comprising detecting for a second detection time the presence or absence of scattered light at a second detector, said second detector positioned to receive light at a second angle to said propagation axis.

10. The process of claim 9 wherein said first detection time and said second detection time are identical.

11. The process of claim 9 wherein said second angle is greater than said first angle.

12. The process of claim 9 wherein said second angle is at or between 15 and 140 degrees.

13. The process of claim 9 wherein said second angle is at or between 80 and 100 degrees.

14. The process of claim 1 wherein said first angle includes zero degrees and wherein a decrease in the intensity of light at said at said first detector identifies a pressure irregularity in said chamber.

15. The process of claim 1 or 14 further comprising the step of adjusting the pressure within said plasma deposition chamber in response to detecting the presence of absence of scattered light at said detector.

16. The process of claim 1 wherein said detection area is on the high-pressure side of a plasma region within said plasma deposition chamber.

17. The process of claim 1 wherein said detection area is defined by a plane of an edge piece located on the high-pressure side of a plasma region within said plasma deposition chamber.

18. The process of claim 1 further comprising the step of polarizing said light beam.

19. The process of claim 1 further comprising the step of collimating said light beam.
